(19) United States
(12) Patent Application Publication
(10) Pub. No.: US 2010/0315655 A1
(43) Pub. Date: Dec. 16, 2010

(54) Method And Device For Measuring A Height Difference

(75) Inventors: Stefan Behler, Steinhausen (CH); Patrick Blessing, Thalwil (CH); Stephan Scholze, Zurich (CH); Roland Stalder, Zurich (CH); Martin Von Arx, Unteraegeri (CH)

Correspondence Address: Nixon Peabody LLP, P.O. Box 60610, Palo Alto, CA, 94306, US

(73) Assignee: ESEC AG, Cham (CH)

(21) Appl. No.: 12/518,098

(22) PCT Filed: Nov. 19, 2007
(86) PCT No.: PCT/EP07/62480

§ 371 Date: Jun. 5, 2009

(30) Foreign Application Priority Data
Dec. 7, 2006 (CH) 1996/06

(51) Int. Cl. G01B 11/02

(52) U.S. Cl. 356/634

(57) ABSTRACT

Determination of the height difference between a first reference point and a second reference point, at least one of the two reference points lying on a semiconductor chip, which is mounted on a substrate, comprises the steps

A) recording a first image from a first direction, which runs diagonally to the surface of the substrate at a predetermined angle α₂, the substrate and the semiconductor chip being illuminated from a second direction which runs diagonally to the surface of the substrate at a predetermined angle α₃, a telecentric optics being located in the beam path,
B) recording a second image from the second direction, the substrate and the semiconductor chip being illuminated from the first direction, either the cited telecentric optics or a further telecentric optics being located in the beam path,
C) ascertaining a first coordinate of the position of the first reference point and a first coordinate of the position of the second reference point in the first image and determining a first difference between these two coordinates,
D) ascertaining a first coordinate of the position of the first reference point and a first coordinate of the position of the second reference point in the second image and determining a second difference between these two coordinates, and
E) calculating the height difference from the first difference and the second difference.

### CROSS REFERENCE TO RELATED APPLICATIONS

The present application is related to and claims priority of the PCT patent application no. PCT/EP2007/062480 entitled “Method And Device For Measuring A Height Difference”, filed Nov. 19, 2007, which in turn claims priority of Swiss patent application no. 1996/06, filed on Dec. 7, 2006, the disclosure of which is herein incorporated by reference.

### TECHNICAL FIELD

The invention concerns a method and a device for measuring a height difference between a first reference point and a second reference point, at least one of the two reference points lying on a semiconductor chip, which is mounted on a substrate.

### BACKGROUND OF THE INVENTION

With the mounting of semiconductor chips, it is important for many processes that the thickness of the adhesive layer formed between the semiconductor chip and the substrate lies within tight tolerance limits. Furthermore, it is important that the semiconductor chip mounted on the substrate demonstrates no inclination (known in technical jargon as “tilt”). To check whether the thickness of the adhesive layer and the inclination of the semiconductor chip do not exceed predefined limit values, equipped substrates have to be removed from the process as random samples and the thickness and inclination determined by means of a measuring microscope. This examination is expensive and the results are only available after a delay.

A further problem frequently occurs in thin semiconductor chips, whose thickness is below 150 μm. Such thin semiconductor chips are sometimes arched after mounting, i.e., no longer planar.

A method for measuring the tilt of a semiconductor chip mounted on a substrate is known from U.S. Pat. No. 7,193,727, in which a light grid is projected onto the semiconductor chip and the substrate. The lines of the light grid experience an offset at the edges of the semiconductor chip. The offset is measured at least three points and the tilt of the semiconductor chip is calculated therefrom. When the thickness of the semiconductor chip is known, the mean thickness of the adhesive layer formed between the semiconductor chip and the substrate may also be calculated. This method may not be used with all semiconductor chips, because the semiconductor chips often contain structures which diffract the incident light.

During the wiring of the semiconductor chip to the substrate using a wire bonder, which follows the mounting, it is advantageous if the current z height of every connection area (pad) of the semiconductor chip is known, so that the capillaries which guide the wire may be lowered at the greatest possible velocity to the connection area without damaging the connection area upon impact.

### SHORT DESCRIPTION OF THE INVENTION

The present invention is based on the object of developing a device for mounting semiconductor chips and a method, using which any tilt of the semiconductor chip and the thickness of the adhesive layer between the semiconductor chip and the substrate may be determined easily.

The method according to the present invention allows the measurement of a height difference between a first reference point and a second reference point, at least one of the two reference points lying on a semiconductor chip mounted on a substrate. The method is characterized by the steps

A) recording a first image from a first direction, which runs diagonally to the surface of the substrate at a predetermined angle α₂, the substrate and the semiconductor chip being illuminated from a second direction which runs diagonally to the surface of the substrate at a predetermined angle α₃, a telecentric optics being located in the beam path,
B) recording a second image from the second direction, the substrate and the semiconductor chip being illuminated from the first direction, either the cited telecentric optics or a further telecentric optics being located in the beam path,
C) ascertaining a first coordinate of the position of the first reference point and a first coordinate of the position of the second reference point in the first image and determining a first difference between these two coordinates,
D) ascertaining a first coordinate of the position of the first reference point and a first coordinate of the position of the second reference point in the second image and determining a second difference between these two coordinates, and
E) calculating the height difference from the first difference and the second difference.

Advantageously, the difference |α₂−α₃| between the angle α₂ and the angle α₃ is at most 1°.

To determine the position of the semiconductor chip, the height of the surface of the mounted semiconductor chip facing away from the substrate in relation to the substrate is measured without contact at least three points and the position of the semiconductor chip is calculated therefrom. Steps A and B only have to be performed once per semiconductor chip, while steps C through E are to be performed for each point of the semiconductor chip whose height difference to the substrate is to be measured.

The position of the semiconductor chip is, for example, defined by the distance of a reference point lying on the surface of the semiconductor chip and two angles φ and θ, which describe how the surface of the semiconductor chip is oriented in space. If at least one of the two angles φ and θ differs from zero, one refers to a tilt of the semiconductor chip.

The local thickness of the adhesive layer at any arbitrary location below the semiconductor chip may then be calculated using the information about the size and thickness of the semiconductor chip. In particular the minimal and maximal thicknesses, as well as a value for the mean thickness of the adhesive layer, may be calculated.

To determine the planarity of the semiconductor chip, for example, the height difference between a point in the center of the semiconductor chip and the corner points of the semiconductor chip is measured.

In addition, the current z height of every connection area of the semiconductor chip may be determined directly before the wiring of the semiconductor chip.

Various devices may be used for the method according to the present invention. For example, the device may contain two cameras and two telecentric optics, which are directed towards the substrate and the semiconductor chip from various directions. An especially advantageous device, however, comprises only a single camera and a telecentric optics situated in front of the camera, as well as three semitransparent mirrors situated parallel to one another and two light sources. The three mirrors and the two light sources are situated in such a way that the camera may record images of the substrate and the semiconductor chip from a first direction and a second direction, the second light source illuminating the substrate and the semiconductor chip from the second direction when recording an image from the first direction, and the first light source illuminating the substrate and the semiconductor chip from the first direction when recording an image from the second direction. Furthermore, the device advantageously comprises a shield which may assume a first position, in which it interrupts the first direction, and which may assume a second position, in which it interrupts the second direction, to avoid double images.

### BRIEF DESCRIPTION OF THE DRAWING FIGURES

The accompanying drawings, which are incorporated into and constitute a part of this specification, illustrate one or more embodiments of the present invention and, together with the detailed description, serve to explain the principles and implementations of the invention. The figures are not to scale. In the drawings:

FIGS. 1, 2 illustrate the measurement principle,

FIG. 3 schematically shows a device in a side view which is capable of recording an image from two different directions, and

FIG. 4 shows two real images.

### DETAILED DESCRIPTION OF THE INVENTION

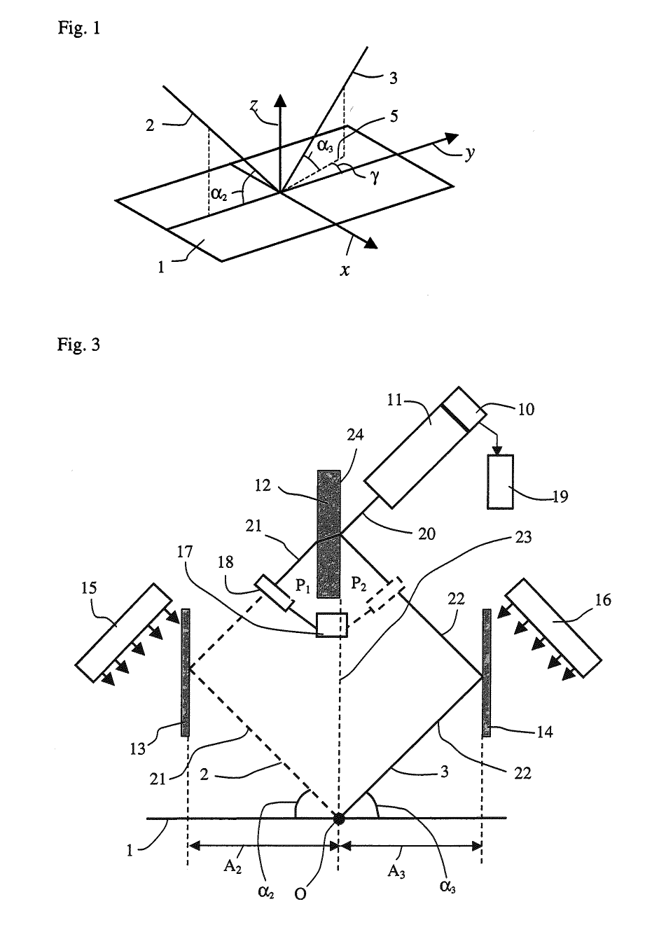

FIGS. 1 and 2 illustrate the measurement principle. FIG. 1 shows an object plane 1, of which a camera records an image from two different directions 2 and 3. The object plane 1 spans a Cartesian coordinate systems having the axes x and y. The direction 2 encloses the angle α₂ with the object plane 1. The direction 3 encloses the angle α₃ with the object plane 1 and the angle γ with the y axis. A substrate 7 (FIG. 2) having a semiconductor chip 8 (FIG. 2) mounted thereon is located in the object plane 1.

FIG. 2 shows the plane 4 spanned by the y axis and the direction 2 on the left side and the plane 6 spanned by an axis 5 and the direction 3 on the right side. An adhesive layer 9 is located between the semiconductor chip 8 and the substrate 7.

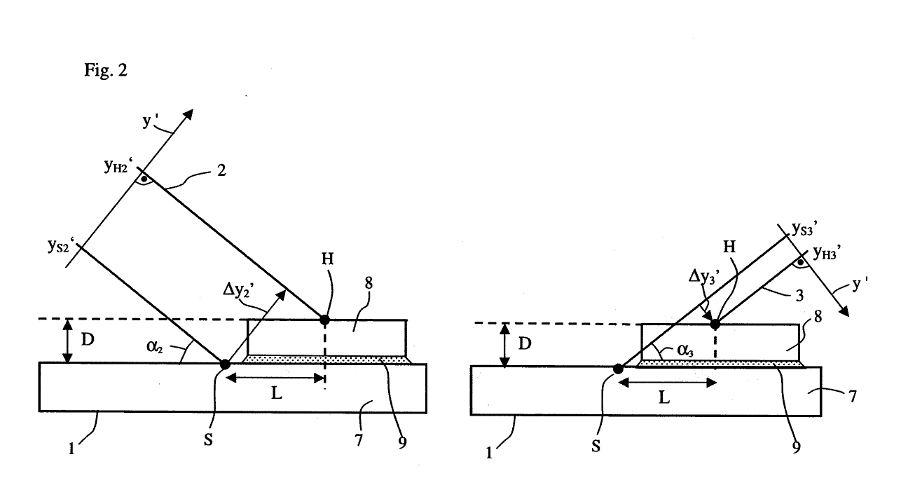

FIG. 3 schematically shows a side view of a device which is capable of recording an image from the direction 2 and an image from the direction 3. The device comprises a camera 10, a telecentric optics 11, three semitransparent mirrors 12, 13, and 14 situated parallel to one another, two light sources 15 and 16, and advantageously a shield 18 driven by a motor 17, which may assume two positions. The device also contains an image processing module 19, which analyzes the images provided by the camera 10 and ascertains the position of predetermined structures on the substrate 7 and the semiconductor chip 8. The three semitransparent mirrors 12-14 are beam splitters: the light scattered and reflected in the object plane 1 on the substrate 7 reaches the camera 10 via a first partial beam 21 when an image is recorded from the first direction 2, and reaches the camera 10 via a second partial beam 22 when an image is recorded from the second direction 3. The first mirror 12 is situated offset in height in relation to the two other mirrors 13 and 14 and ensures that both partial beams 21 and 22 are unified into one beam 20. The two other mirrors 13 and 14 reflect the corresponding partial beam 21 or 22 and are additionally used for coupling in light emitted from the light sources 15 and 16, to illuminate the object plane 1 from the direction 2 or 3. The substrate 7 and the semiconductor chip 8 contain metallic structures which reflect the incident light, while the nonmetallic areas of the substrate 7 or its surroundings and the semiconductor chip 8 typically diffusely scatter the incident light. The angles α₂ and α₃ are advantageously of equal size, notwithstanding mounting tolerances, so that the metallic structures stand out in high contrast from their surroundings in the images. The shield 18 either assumes the position P₁ shown by a solid line in FIG. 3 or the position P₂ shown by a dashed line. The telecentric optics 11 is used for avoiding a distortion of the image which is caused because the object plane 1 runs diagonally to the direction 2 or 3. The telecentric optics 11 only images beams which run axially parallel, so that the enlargement is independent of the object distance. The properties of a telecentric optics may be reviewed in the Internet lexicon “Wikipedia”, for example.

To record an image from the direction 2, the shield 18 is brought into the position P₂, so that it interrupts the partial beam 22, the light source 15 is turned off, and the light source 16 is turned on. To record an image from the direction 3, the shield 18 is brought into the position P₁, so that it interrupts the partial beam 21, the light source 16 is turned off, and the light source 15 is turned on. The shield 18 is used for eliminating double images. Without the shield 18, light scattered at the object plane 1 would also reach the camera 10 on the partial beam interrupted by the shield 18 and be noticeable as an undesired ghost image.

The two partial beams 21 and 22 originate from a point O in the object plane 1. As is obvious from FIG. 3, the point O is in the same plane 23 as the surface 24 of the first mirror 12 facing toward the camera 10. The distance A₂ between the surface 24 of the first mirror 12 and the second mirror 13 is advantageously greater than the distance A₃ between the surface 24 of the first mirror 12 and the third mirror 14, so that the focal plane of the camera 10 goes through the point O in both cases. The difference A₂−A₃ is a function of the index of refraction n and the thickness d of the first mirror 12. The following equation applies: A₂=A₃+0.5*d*(1−1/n).

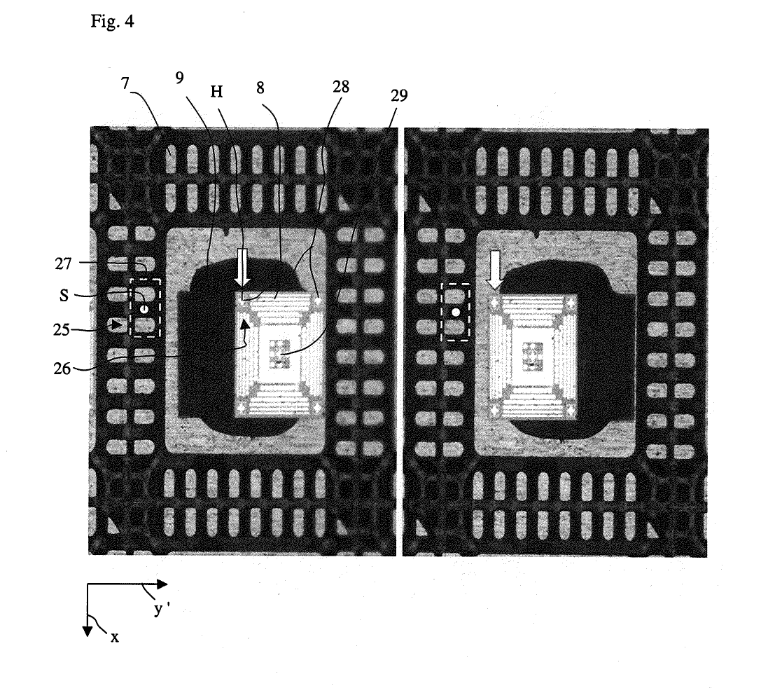

FIG. 4 comprises two real images, which show a detail of the substrate 7 and the semiconductor chip 8 (the reference numerals are only entered in the left image). The image on the left side was recorded from the direction 2 (FIGS. 2, 3), and the image on the right side from the direction 3 (FIGS. 2, 3). The coordinate axis x corresponds to the coordinate axis x of FIG. 1. The coordinate axis y, in contrast, appears distorted in the image of the camera 10 as the coordinate axis y′, namely shortened by the factor sin α₂ in the image recorded from the direction 2 or shortened by the factor sin α₃ in the image recorded from the direction 3. The image processing module 19 has the task of determining the y′ coordinate of a reference point S on the substrate 7 and the y′ coordinate of a reference point H on the semiconductor chip 8. An arbitrary point on the substrate 7 may be selected as the reference point S and an arbitrary point on the semiconductor chip 8 may be selected as the reference point H. In order that the image processing module 19 may determine the y′ position of the two reference points S and H with high precision, structures 25 are selected on the substrate 7 and structures 26 are selected on the semiconductor chip 8, which advantageously have edges which have noticeable brightness differences along the y direction. The structures 25 define the reference point S, the structures 26 define the reference point H. For example, a rectangle 27 is assigned to the structures 25, and the reference point S is defined as the center point of the rectangle 27. Another rectangle may be assigned in the same way to the structures 26 and the reference point H may be defined as the center point of this other rectangle. In this example, however, the structures 26 are a cross 28 known as a fiducial cross in technical jargon and the reference point H is defined as the center point of the cross 28. Because the semiconductor chip has such a cross in each corner, an arrow points to the selected cross. The rectangle 27, the reference point S, and the arrow are not part of the image, but are overlaid in the image for understanding. The image processing module ascertains the y′ coordinate y_{S2}′ of the center point of the rectangle 27 and the y′ coordinate y_{H2}′ of the center point of the cross 28 in the image recorded from the direction 2 and the y′ coordinate y_{S3}′ of the center point of the rectangle 27 and the y coordinate y_{H3}′ of the center point of the cross 28 in the image recorded from the direction 2. A first distance Δy₂′=y_{H2}′−y_{S2}′ is calculated between the reference point H and the reference point S in the first image and a second distance Δy₃′=y_{H3}′−y_{S3}′ between the reference point H and the reference point S is calculated in the second image. The two distances Δy₂′ and Δy₃′ are absolute distances measured in the y′ direction. The camera 10 provides the distances Δy₂′ and Δy₃′ in pixel units. They may be converted into metric units by multiplication using a conversion factor k₂ or k₃. The following equations thus result from FIG. 2:

k₂*Δy₂′=L sin □₂+D cos □₂ (1)

k₃*Δy₃′=L sin □₃−D cos □₃ (2)

and the distance D results as

D=[k₂*Δy₂′/sin α₂−k₃*Δy₃′/sin α₃]/[cot α₂+cot α₃] (3)

The distance D corresponds to the height difference between the substrate 7 and the semiconductor chip 8 at the location of the cross 28, i.e., at the location of the reference point H.

The following is also noted in regard to the reference points S and H: in principle, it is important that the reference point S and the reference point H are selected on one image and the image processing module searches for the identical reference points S and H in the other image.

In order that the tilt of the semiconductor chip may be determined, the height difference must be measured at least three points. I.e., three difference reference points H are to be selected on the semiconductor chip 8 and their heights are to be determined in relation to the substrate 7. The reference point S on the substrate 7 may be identical, or three difference reference points S may be selected, which are in proximity to the corresponding reference point H on the semiconductor chip 8.

Before the tilt of the semiconductor chip may be determined, the device according to the present invention must be calibrated. The determination of the angles α₂ and α₃ and the conversion factors k₂ and k₃ is performed using a calibration plate, for example, which contains reference marks applied at precisely predefined distances Δx=Δy, such as round dots. The calibration plate is oriented in such a way that the x direction runs perpendicularly to the plane of the drawing of FIG. 3. The camera 10 records an image from the direction 2 and the image processing module 19 ascertains the distances Δx′ and Δy′ between the centers of the points in pixel units. The angle α₂ results as

α₂=arcsin(Δy′/Δx′) (4)

The conversion factor k₂ for the conversion from pixel units into metric units results as

k₂=Δx/Δx′ (5)

The camera 10 then records an image from the direction 3 and the image processing module 19 ascertains the distances Δx′ and Δy′ between the centers of the dots in pixel units. The angle α₃ results as

α₃=arcsin(Δy′/Δx′) (6)

and the conversion factor k₃ for the conversion from pixel units into metric units results as

k₃=Δx/Δx′ (7)

The mirrors 12-14 deviate from their ideal position within certain tolerances, with the result that the angle γ (FIG. 1) is not zero. If the value of the angle γ exceeds a predetermined maximum value γ₀, the angle γ is also to be considered when determining the distance D. The distance D may then be ascertained according to the following steps:
1. The image recorded from the direction 3 is corrected, i.e. the image is stretched in the y′ direction: the y′ coordinate is multiplied by the factor 1/sin α₃.
2. The stretched image is rotated by the angle −γ.
3. The rotated image is distorted again, i.e., the image is shortened in the y direction: the y′ coordinate is multiplied by the factor sin α₃.
4. The distance D is now again determined in the way described above using the original image recorded from the direction 2 and the image recorded from the direction 3 and corrected according to prior steps 1 through 3.

Because the angle γ is a relative angle which indicates by what absolute value the two directions 2 and 3 are pivoted to one another around the z axis, alternatively, the original image recorded from the direction 3 may be used, and steps 1 through 3 may be performed for the image recorded from the direction 2, the image being stretched by the factor 1/sin α₂, then rotated by the angle +γ, and finally shortened by the factor sin α₂ to determine the distance D.

The tilt of the semiconductor chip 8 may be determined by measuring the distance D at at least three points using the method described above. If the thickness of the semiconductor chip 8 is known, a parameter may also be ascertained which characterizes the adhesive layer. The parameter is the mean thickness of the adhesive layer, for example, or the minimal or maximum value of the thickness of the adhesive layer. These analyses are known per se, for example, from German Patent Application DE 10 2004 043084, to which reference is explicitly made here, and are therefore not explained here.

The described method may also be applied to measure the planarity of the surface of the semiconductor chip 8. In particular thin semiconductor chips whose thickness is less than 150 μm may be arched after mounting. The degree of arching may be characterized, for example, by the height difference between a point in the center of the semiconductor chip 8 and the four corner points of the semiconductor chip 8. The semiconductor chip 8 of FIG. 4 contains a metallic cross 29 in the center. The image processing module 19 determines the y′ coordinate of the center point of the cross 29 in both images and then calculates the height of the center point in relation to the reference point S. If the height of the four crosses 28 in the corner points of the semiconductor chip 8 in relation to the reference point S are identified by K₁, K₂, K₃, and K₄ and the height of the cross 29 in relation to the reference point S is identified by K₅, the degree of arching W results as

W=K₅−[K₁+K₂+K₃+K₄]/4 (8).

The degree of arching W may also be determined in other ways, however. For example, the four height differences ΔK₁, ΔK₂, ΔK₃, and ΔK₄ between the cross 29 and the four crosses 28 may be determined (similarly to the determination of the height difference between the reference point S on the substrate and the reference point H on the semiconductor chip 8, with the single difference that here both reference points S and H lie on the semiconductor chip 8). The degree of arching then results as

W=[ΔK₁+ΔK₂+ΔK₃+ΔK₄]/4 (9).

The determination of the degree of arching W using the equation (8) or (9) offers the advantage that the tilt of the semiconductor chip 8 is automatically considered.

What is claimed is:

1. A method for measuring a height difference between a first reference point and a second reference point, at least one of the first and second reference points lying on a semiconductor chip, the chip mounted on a surface of a substrate, the method comprising:
recording a first image from a first direction, which runs diagonally to the surface of the substrate at a predetermined angle α₂, the substrate and the semiconductor chip being illuminated by a beam of light along a first beam path from a second direction which runs diagonally to the surface of the substrate at a predetermined angle α₃, a first telecentric optics located in the first beam path;
recording a second image from the second direction, the substrate and the semiconductor chip being illuminated by a beam of light along a second beam path from the first direction, either the first telecentric optics or a second telecentric optics located in the second beam path;
ascertaining a first coordinate of a position of the first reference point and a first coordinate of a position of the second reference point in the first image and determining a first difference between these two coordinates;
ascertaining a first coordinate of the position of the first reference point and a first coordinate of the position of the second reference point in the second image and determining a second difference between these two coordinates; and
calculating the height difference from the first difference and the second difference.

2. A method according to claim 1, wherein the difference between the angle α₂ and the angle α₃ is less than or equal to 1°.

3. A device for measuring a height difference between a first reference point and a second reference point, at least one of the first and second reference points lying on a semiconductor chip mounted on a substrate, the device comprising:
a single camera;
a telecentric optics situated in front of the camera;
a first, second and third semitransparent mirror arranged parallel to one another; and
two light sources, the three mirrors and the two light sources configured (1) to permit the camera to record images of the substrate and the semiconductor chip from both a first direction and a second direction; (2) to permit the substrate and the semiconductor chip to be illuminated from the second direction to record an image from the first direction; and (3) to permit the substrate and the semiconductor chip to be illuminated from the first direction to record an image from the second direction.

4. The device according to claim 3, further comprising:
a shield configured to assume one of a first position, in which it interrupts the first direction, and a second position, in which it interrupts the second direction.

5. A device according to claim 3, wherein a distance between a surface of the first mirror and the second mirror, wherein the surface of the first mirror faces toward the camera and the second mirror is configured to permit the recording of an image from the first direction, is greater than a distance between the surface of the first mirror and the third mirror, which is configured to permit the recording of an image by the camera from the second direction.

6. A device according to claim 4, wherein a distance between a surface of the first mirror and the second mirror, wherein the surface of the first mirror faces toward the camera and the second mirror is configured to permit the recording of an image by the camera from the first direction, is greater than a distance between the surface of the first mirror and the third mirror, which is configured to permit the recording of an image by the camera from the second direction.
